(19) United States
(12) Patent Application Publication
(10) Pub. No.: US 2020/0358348 A1
(43) Pub. Date: Nov. 12, 2020

(54) CONVERTER ASSEMBLY

(71) Applicant: SIEMENS AKTIENGESELLSCHAFT, MUENCHEN (DE)

(72) Inventors: ULRICH HALFMANN, LANGENSENDELBACH (DE); ANDRE SCHOEN, ERLANGEN (DE)

(21) Appl. No.: 16/642,236

(22) PCT Filed: Sep. 1, 2017
(86) PCT No.: PCT/EP2017/072004

§ 371 Date: Feb. 26, 2020

(51) Int. Cl. H02M 1/32; H02M 7/217

(52) U.S. Cl. CPC H02M 1/32; H02M 7/217

(57) ABSTRACT

A converter assembly includes a converter unit having AC voltage connection points feeding in or tapping an alternating current, and first and second DC voltage connection points feeding in or tapping a direct current. Parallel series circuits associated with an AC voltage connection point each have first and second circuit connection points respective connected to first and second DC voltage connection points. Each series circuit has submodules connected in series. For each series circuit the AC voltage connection point divides submodules into submodule groups electrically close to first and electrically close to second series circuit connection points. One DC voltage connection point is grounded. For each series circuit the AC voltage connection point divides the submodules into a submodule group electrically close to and a submodule group electrically remote from ground. Submodule groups close to ground have a bipolar submodule and submodule groups remote from ground have unipolar submodules.

The invention relates to a converter assembly having the characteristics according to the introductory clause of patent claim 1.

A converter assembly of this type is known from international patent application WO 2013/071947 A1. This previously known converter assembly comprises at least one converter unit. The converter unit comprises at least two AC voltage connection points, at each of which an alternating current can be injected or tapped, and a first and a second DC voltage connection point, at which a direct current can be injected or tapped. For each AC voltage connection point, the converter unit respectively comprises a series circuit, which is assigned to the respective AC voltage connection point. The series circuits are electrically connected in parallel. In each series circuit, a first series circuit connection point is respectively connected to the first DC voltage connection point of the converter unit, and a second series circuit connection point is connected to the second DC voltage connection point of the converter unit. Each of the series circuits respectively comprises series-connected submodules. In each of the series circuits, the AC voltage connection point respectively subdivides the submodules into a submodule group which is electrically close to the first series circuit connection point, and a submodule group which is electrically close to the second series circuit connection point.

Converter assemblies of this type can be employed in high-voltage direct current (HVDC) transmission and, where they comprise two converter units, can constitute a HVDC bipole structure. If they are equipped with unipolar submodules, for example half-bridge submodules, asymmetrical line-to-ground short-circuits—described hereinafter as asymmetrical AC faults—associated with the rectification action of the half-bridge submodules, which assume a blocked state further to fault detection, can result in a DC current offset in the two phases of the AC voltage network (AC network) which are not affected by the ground fault. AC circuit-breakers, which are intended to isolate the converter assembly from the AC network in such cases, only constitute a surge-proof separation path in the event of a preceding current zero-crossing. As a result of the DC current offset associated with the fault described, the current zero-crossing fails to occur, such that the circuit-breaker cannot constitute a separation path. Even with back-up protection, this results, under certain circumstances, in the destruction of the circuit-breakers and damage to the power electronics of the converter assembly.

This problem can be resolved by an additional short-circuit unit, which establishes a three-pole AC short-circuit. In the event of a fault, a hard three-pole short-circuit is generated from a single-pole or two-pole line-to-ground fault, such that the fault current is symmetrized. However, this involves a massive impairment of the AC network.

As the asymmetrical AC faults described are high-current faults, no direct distinction can be drawn, in the event of a fault, between the presence of an internal converter fault or an asymmetrical AC fault of the type described. Consequently, in the event of any high-current fault, it is necessary for the short-circuiter to be tripped. This means that any high-current fault on the converter assembly has massive repercussions on the AC network.

In a bipole structure, this problem can also be resolved by the impedance grounding at a point between the two converter units (sub-converters). By means of a very high impedance in the grounding path, the fault current, and thus the DC current offset, is limited, such that the achievement of current zero-crossings in AC circuit-breakers can be maintained. However, the pre-charge voltage of connected DC cables constitutes a substantial thermal load in this grounding arrangement. Moreover, the grounding path cannot be employed as a third conductor/return conductor for the bipole structure.

The object of the invention is the disclosure of a converter assembly which, in the event of an asymmetrical line-to-ground short-circuit on an AC voltage connection point, permits the simple and rapid separation of the converter assembly from the AC network.

This object is fulfilled according to the invention by a converter assembly having the characteristics claimed in patent claim 1. Advantageous configurations of the converter assembly according to the invention are disclosed in the sub-claims.

According to the invention, it is provided that one of the two DC voltage connection points of the converter unit is grounded, for each of the series circuits the associated AC voltage connection point respectively subdivides the submodules into a submodule group which is electrically close to ground and a submodule group which is electrically remote from ground, the submodule groups which are close to ground comprise at least one bipolar submodule, and the submodule groups which are remote from ground are comprised exclusively of unipolar submodules.

A key advantage of the converter assembly according to the invention is provided in that, by the provision of at least one bipolar submodule in each of the submodule groups which are close to ground respectively, a displacement of the DC current offset of a type such that no current zero-crossings occur at the AC voltage connection points of the converter assembly, in the event of an asymmetrical AC ground fault, can be prevented. Given that, on the AC voltage side, zero-crossings occur even in the event of a ground fault, the AC voltage side can be rapidly and simply separated from the external network by means of circuit-breakers. By means of the bipolar submodules, namely in the event of an asymmetrical line-to-ground short-circuit on one AC voltage connection point, a counter-voltage is constituted on the remaining unaffected phases, for both polarities, which limits the asymmetrical fault current such that current zero-crossings continue to be executed in the circuit-breakers.

By way of distinction from the above-mentioned alternative measures for the management of asymmetrical line-to-ground short-circuits, the massive repercussions upon the network, associated with active short-circuiters, do not occur. Moreover, the system can be rigidly grounded (i.e. with a low ground impedance). Accordingly, potential displacements associated with the pre-charging of the cable run or with ground faults cannot occur.

A further key advantage of the converter assembly according to the invention is provided in that expensive bipolar submodules are only employed in those locations where they will be useful, namely, in the submodule groups which are close to ground; in the submodule groups which are remote from ground, only unipolar submodules are employed.

In the submodule groups which are close to ground, the ratio between the number of bipolar submodules and the total number of submodules preferably lies between ¼ and ¾ in each case.

The converter assembly preferably comprises a first and a second converter unit, each of which comprises at least two AC voltage connection points, at each of which an alternating current can be injected or tapped, and a first and second DC voltage connection point, at which a direct current can be injected or tapped, wherein the converter units, for each AC voltage connection point, respectively comprise one series circuit which is assigned to the respective AC voltage connection point, the series circuits of each converter unit are respectively electrically connected in parallel, in each series circuit a first series circuit connection point is respectively connected to the first DC voltage connection point of the respective converter unit, and a second series circuit connection point is connected to the second DC voltage connection point of the respective converter unit, each of the series circuits respectively comprises series-connected submodules, namely, unipolar submodules and bipolar submodules and, in each of the series circuits, the AC voltage connection point respectively subdivides the submodules into a submodule group which is electrically close to the first series circuit connection point, and a submodule group which is electrically close to the second series circuit connection point.

In the last-mentioned configuration, it is advantageous if the first DC voltage connection point of the first converter unit constitutes a first DC voltage connection point of the converter assembly, the first DC voltage connection point of the second converter unit constitutes a second DC voltage connection point of the converter assembly, the second DC voltage connection points of both converter units are grounded, and the AC voltage connection points of both converter units, in pairs, constitute an AC voltage connection point of the converter assembly, either separately or in combination with other components.

In each of the series circuits of the first and second converter unit, the associated AC voltage connection point preferably subdivides the submodules into one submodule group which is electrically close to ground and one submodule group which is electrically remote from ground respectively.

The submodule groups which are close to ground preferably comprise at least one bipolar submodule, and the submodule groups which are remote from ground are exclusively comprised of unipolar submodules.

In the case of two converter units, it is also advantageous if, in the submodule groups which are close to ground, the ratio between the number of bipolar submodules and the total number of submodules preferably lies between ¼ and ¾ in each case.

The bipolar submodules are preferably protected against overvoltages by one or more voltage limiting devices.

In each case, a dedicated voltage limiting device is preferably electrically connected in parallel with each of the bipolar submodules. In this configuration, it is advantageous if the voltage limiting devices respectively limit the capacitor voltage of a capacitor of the associated bipolar submodule to a predefined maximum capacitor voltage.

In an advantageous manner, it can also be provided that the bipolar submodules, in at least one of the submodule groups which is close to ground, and preferably in all of the submodule groups which are close to ground respectively, are mutually interconnected within their respective submodule group which is close to ground to constitute a series circuit of bipolar submodules in each case. In this variant, it is moreover advantageous if a voltage limiting device is respectively electrically connected in parallel with each of the series circuits of bipolar submodules.

In the last-mentioned variant, it is moreover advantageous if the voltage limiting devices respectively limit the sum of the capacitor voltages of the capacitors of the bipolar submodules in the associated series circuit of bipolar submodules to a predefined maximum total capacitor voltage.

The unipolar submodules are preferably such that their submodule voltage can only be delivered with a single polarity.

The bipolar submodules are preferably such that their submodule voltage can optionally be delivered with a positive or a negative polarity. It is also advantageous if the bipolar submodules are such that their submodule voltage can optionally be delivered with a positive or a negative polarity, but at different voltage levels.

The unipolar submodules are preferably constituted in each case by a series circuit having two switches, each of which comprises a switching element and a parallel-connected diode, and a capacitor which is connected in parallel with the series circuit.

The bipolar submodules are preferably constituted in each case by two parallel-connected series circuits, each having two switches, each of which comprises a switching element and a parallel-connected diode, and a capacitor which is connected in parallel with the parallel circuit of series circuits.

The voltage limiting devices preferably comprise non-linear resistors, or are constituted by the latter.

The voltage limiting devices are preferably arresters.

The invention is described in greater detail hereinafter with reference to exemplary embodiments; herein, for exemplary purposes:

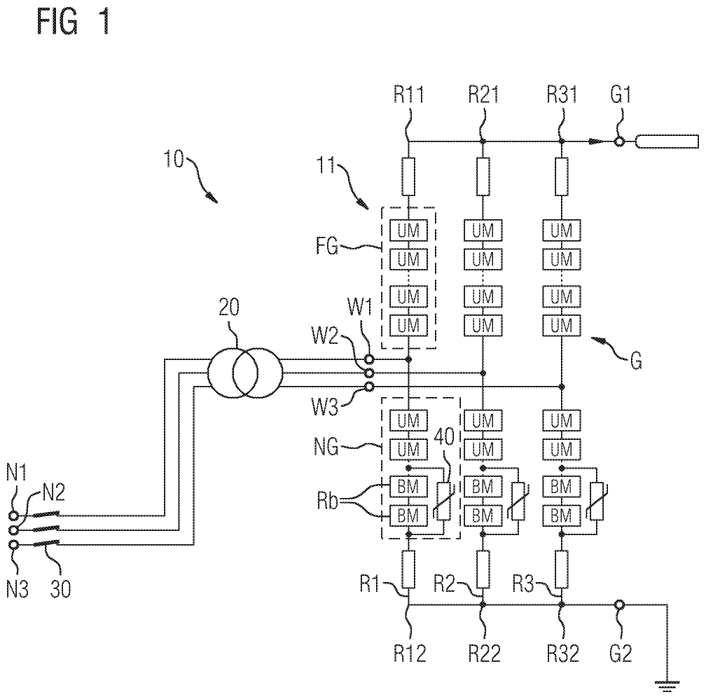

FIG. 1 shows an exemplary embodiment of a converter assembly according to the invention, which is equipped with a single converter unit,

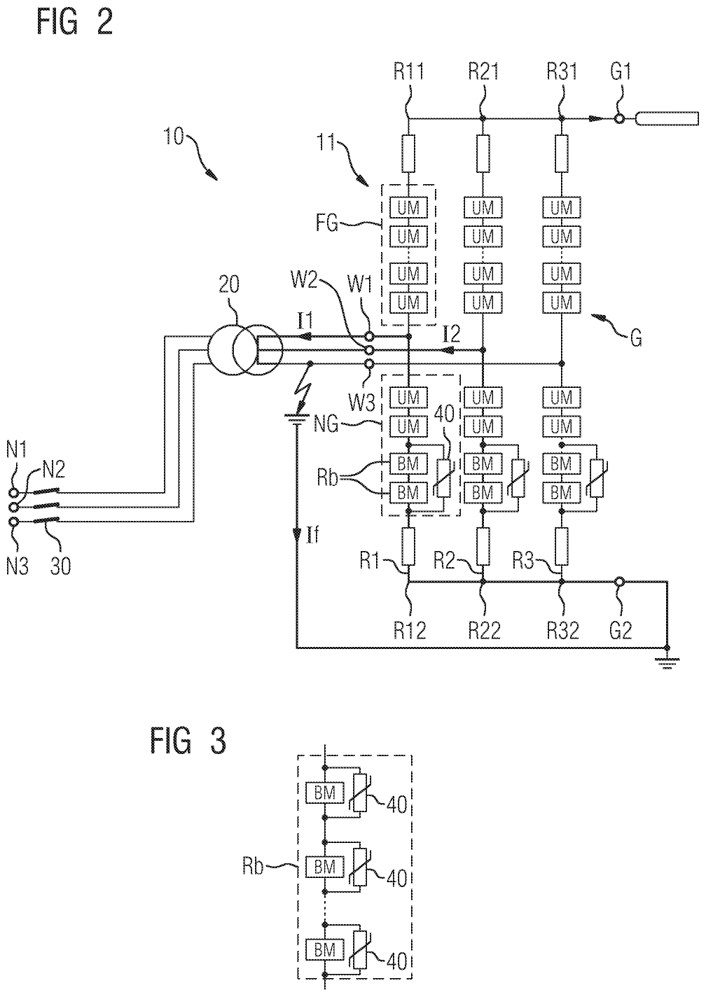

FIG. 2 shows the converter assembly according to FIG. 1, in the event of a ground fault on an AC voltage connection point of the converter assembly,

FIG. 3 on the basis of a submodule group of the converter assembly according to FIG. 1 which is close to ground, shows a further advantageous arrangement of voltage limiting devices,

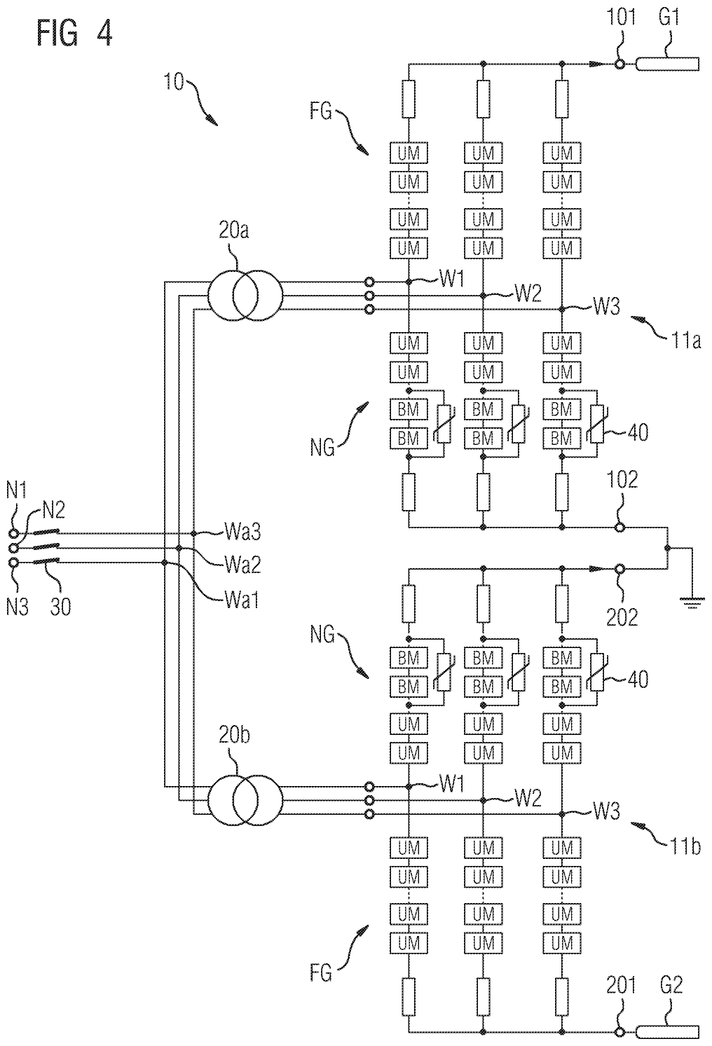

FIG. 4 shows an exemplary embodiment of a converter assembly according to the invention, which is equipped with two converter units and constitutes a bipole structure,

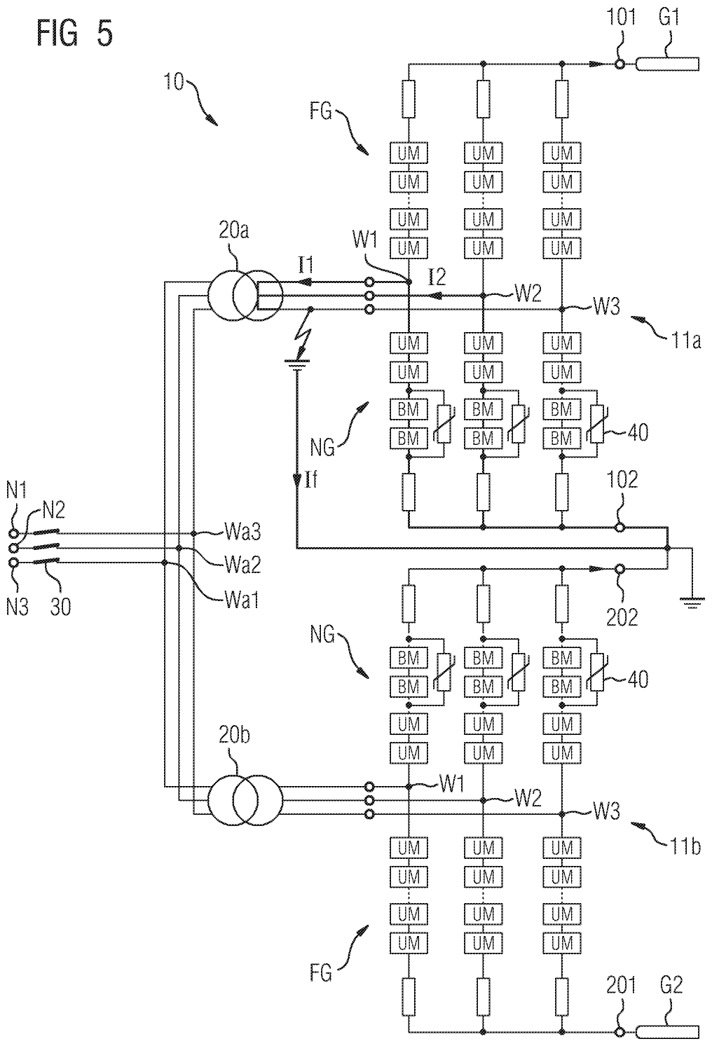

FIG. 5 shows the converter assembly according to FIG. 4 in the event of a ground fault on an AC voltage connection point,

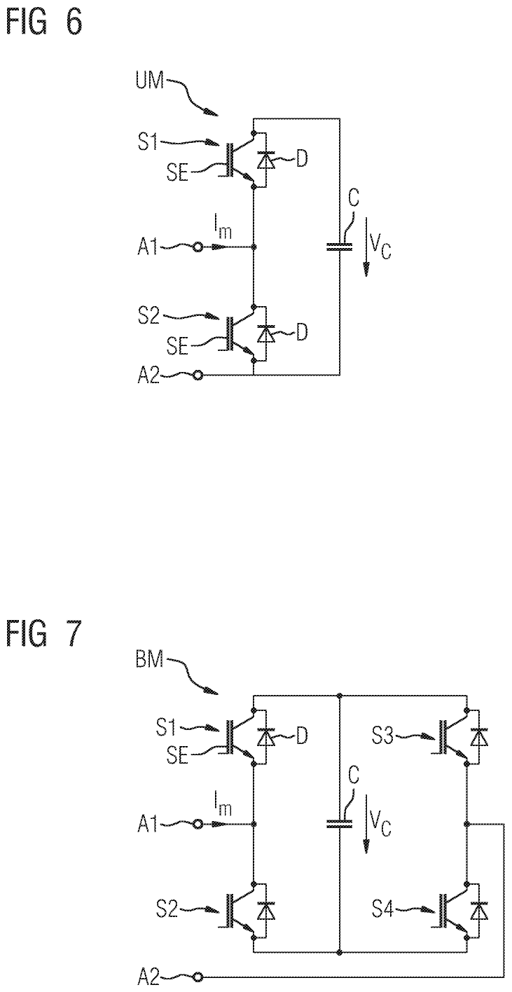

FIG. 6 shows an exemplary embodiment of a unipolar submodule which can be employed in the converter assemblies according to FIGS. 1 to 5, and

FIG. 7 shows an exemplary embodiment of a bipolar submodule which can be employed in the converter assemblies according to FIGS. 1 to 5.

In the figures, in the interests of clarity, the same reference numbers are employed for identical or comparable components in each case.

FIG. 1 shows an exemplary embodiment of a three-phase converter assembly 10, which comprises a converter unit 11. The converter unit comprises AC voltage connection points W1, W2 and W3 for the injection and tapping of alternating current. The converter unit is further equipped, on a DC voltage side G, with a first, in FIG. 1, upper DC voltage connection point G1, and a second, in FIG. 1, lower DC voltage connection point G2. A direct current can be injected or tapped at the DC voltage connection points G1 and G2. The lower DC voltage connection point G2 in FIG. 1 lies at the ground potential.

The converter unit 11 comprises three parallel-connected series circuits R1, R2 and R3, the external connection points R11, R21 and R31 of which are connected to the first DC voltage connection point G1. The other external connection points R12, R22 and R32 of the three parallel-connected series circuits R1, R2 and R3 are connected to the second DC voltage connection point G2, and thus lie at the ground potential.

Each of the series circuits R1, R2 and R3 respectively comprises series-connected submodules, namely, unipolar submodules UM and bipolar submodules BM.

The AC voltage connection points W1, W2 and W3 are respectively assigned to one of the series circuits R1, R2 or R3 and, in the latter, respectively subdivide the submodules into a submodule group NG which is electrically close to ground and a submodule group FG which is electrically remote from ground. The submodule groups NG which are electrically close to ground in the three series circuits R1, R2 and R3 are respectively connected to the second DC voltage connection point G2 of the converter unit 11, and thus to the ground potential; the submodule groups FG which are remote from ground in the three series circuits R1, R2 and R3 are respectively connected to the first DC voltage connection point G1.

The submodule groups NG which are close to ground comprise both bipolar submodules BM and unipolar submodules UM, whereas the submodules groups FG which are remote from ground are respectively comprised exclusively of unipolar submodules UM.

The number of submodules in the submodule groups NG which are close to ground and in the submodule groups FG which are remote from ground are preferably of equal size.

In the exemplary embodiment according to FIG. 1, the submodule groups FG which are remote from ground and the submodule groups NG which are close to ground each comprise four submodules. This is to be understood by way of an example only. The submodule groups can also comprise more or fewer submodules.

In the exemplary embodiment according to FIG. 1, the submodule groups NG which are close to ground comprise two bipolar submodules BM; instead, more or fewer bipolar submodules can also be present. It is considered advantageous if, in the submodule groups NG which are close to ground, the ratio between the number of bipolar submodules BM and the total number of submodules lies between ¼ and ¾ in each case.

The AC voltage connection points W1, W2 and W3 are connected to the network connection points N1, N2 and N3 via a transformer 20 and circuit-breakers 30.

FIG. 2 shows the converter assembly 10 according to FIG. 1 in the event of a ground fault between the AC voltage connection point W3 and the transformer 20. It can be seen that the series circuit R3 is short-circuited, and a fault current If flows via the series circuits R1 and R2 and the transformer 20 to ground, even after—further to fault detection—all the submodules UM and BM, or the switching elements thereof (c.f. FIGS. 6 and 7), have been disconnected. Currents flow via diodes, which are arranged in parallel with the switched-out switching elements. The fault current If is injected via the network connection points N1, N2 and N3 and the transformer 20 from an external energy supply network, which is not represented in greater detail, which is connected to the network connection points N1, N2 and N3.

The partial currents I1 and 12 flowing via the AC voltage connection points W1 and W2 charge the capacitors which are present in the unipolar submodules UM and in the bipolar submodules BM (c.f. FIGS. 6 and 7). Given that, with the unipolar submodules UM in the switched-out state, current only flows through the capacitor in one current direction, and bypasses the latter in the other current direction, the unipolar submodules UM consistently deliver their submodule voltages—in relation to the output connection points of the submodules—with a single polarity only; the bipolar submodules, conversely, in the switched-out state, are capable of conducting current in both directions, and of delivering submodule voltages—in relation to the output connection points of the submodules—with either a positive or a negative polarity.

Accordingly, the bipolar modules BM of the submodule groups NG which are close to ground, in the event of a fault, can respectively constitute a counter-voltage for both polarities, which limits the asymmetrical fault current If and thus compels the execution of current zero-crossings in the currents flowing through the circuit-breakers 30. These current zero-crossings, in turn, permit the opening of the circuit-breakers 30 at the time point of the respective zero-crossing.

Given that the capacitors of the bipolar submodules BM, which are not represented in FIGS. 1 and 2 in the interests of clarity, are charged in the event of both a positive current flow and a negative current flow, the capacitor voltage in the fault scenario represented in FIG. 2 rises continuously and, specifically on the grounds of bidirectional operation, rises twice as rapidly than in the case of unipolar submodules.

In order to prevent the destruction of capacitors in the bipolar submodules BM, these are preferably protected against overvoltages by one or more voltage limiting devices. In the exemplary embodiment according to FIGS. 1 and 2, the bipolar submodules BM of each series circuit R1, R2 and R3 are directly connected in each case, and constitute a series circuit Rb of bipolar submodules. A voltage limiting device 40 is respectively connected in parallel with each series circuit Rb of bipolar submodules.

The voltage limiting devices 40 can be, for example, non-linear resistors or arresters which, upon the achievement of a threshold voltage, assume a low resistance and divert the current from the submodules. Voltage limiting non-linear resistors and arresters of this type are generally known in electrical engineering.

The voltage limiting devices 40 are respectively dimensioned such that they limit the sum of the submodule voltages of the associated bipolar submodules of the series circuit Rb to a predefined maximum voltage.

FIG. 3 shows an alternative, but nevertheless advantageous configuration of overvoltage protection for the submodule groups NG which are close to ground according to FIGS. 1 and 2, in greater detail. It can be seen that each bipolar submodule BM of the submodule group NG which is close to ground is respectively equipped with an individually assigned voltage limiting device 40. The switching voltage or the protection voltage of the voltage limiting devices 40 is respectively defined with reference to the maximum permissible submodule voltage of the respective bipolar submodule BM.

If the bipolar submodules BM are equipped with dedicated voltage limiting devices 40, they can be connected directly to constitute a series circuit Rb, as represented in FIG. 3 or, alternatively, can be interconnected with the unipolar submodules UM in a combined arrangement.

Otherwise, the above statements with respect to FIGS. 1 and 2 apply correspondingly.

FIG. 4 shows an exemplary embodiment of a converter assembly 10 which is equipped with a first converter unit 11a and a second converter unit 11b. The two converter units 11a and 11b are preferably of identical design.

A first DC voltage connection point 101 of the first converter unit 11a constitutes a first DC voltage connection point G1 of the converter assembly 10. A second DC voltage connection point 102 of the first converter unit 11a is grounded or assumes a ground potential.

A first DC voltage connection point 201 of the second converter unit 11b constitutes a second DC voltage connection point G2 of the converter assembly 10. A second DC voltage connection point 202 of the second converter unit 11b, in common with the second DC voltage connection point 102 of the first converter unit 11a, assumes a ground potential or is grounded.

The AC voltage connection points W1, W2 and W3 of the two converter units 11a and 11b, via a respectively associated transformer 20a or 20b, constitute three AC voltage connection points Wa1, Wa2 and Wa3 of the converter assembly 10.

The AC voltage connection points Wa1, Wa2 and Wa3 of the converter assembly 10 are connected, via circuit-breakers 30, to the network connection points N1, N2 and N3.

The two converter units 11a and 11b, in common with the converter unit 11 according to FIGS. 1 and 2, can be of identical design such that, with respect to the layout of the converter units 11a and 11b, reference may be made to the above statements with respect to FIGS. 1 and 2. Additionally, it should only be emphasized once more that, in each of the two converter units 11a and 11b, the AC voltage connection points W1, W2 and W3 respectively subdivide the submodules into a submodule group NG which is close to ground and a submodule group FG which is remote from ground. The submodule groups FG which are remote from ground are comprised exclusively of unipolar submodules UM, whereas the submodule groups NG which are close to ground respectively comprise at least one bipolar submodule BM, and are otherwise comprised of unipolar submodules UM.

On the grounds of the electrical interconnection of the converter units 11a and 11b, the converter assembly 10 constitutes a “bipole structure”, which is appropriate for use in high-voltage direct current (HVDC) electricity transmission. Accordingly, the converter assembly 10 according to FIG. 4 can also be described as a HVDC bipole structure.

FIG. 5 shows the converter assembly 10 according to FIG. 4, in the event of a ground fault in the region of the AC voltage connection point W3 of the upper converter unit 11a represented in FIGS. 4 and 5. It can be seen that a fault current If flows via the two remaining AC voltage connection points W1 and W2.

By means of the fact that the submodule groups NG which are close to ground respectively comprise at least one bipolar submodule BM, it is ensured that zero-crossings occur in the fault currents flowing through the circuit-breakers 30, such that the opening of the circuit-breakers 30 at zero current remains possible.

In the exemplary embodiment according to FIG. 4, the bipolar submodules BM are respectively connected to a series circuit of bipolar submodules, each of which is protected by a voltage limiting device 40, as is also the case in the exemplary embodiment according to FIGS. 1 and 2. Alternatively—analogously to the exemplary embodiment according to FIG. 3—it can be provided that the bipolar submodules BM are respectively equipped with an individually assigned voltage limiting device 40. In this regard, reference may be made to the above statements with respect to FIG. 3.

FIG. 6 shows an exemplary embodiment of a unipolar submodule UM, which can be employed in the converter assemblies 10 according to FIGS. 1 to 5. The unipolar submodule UM comprises a series circuit having two switches S1 and S2, each of which comprises a switching element SE and a parallel-connected diode D. A capacitor C is connected in parallel with the series circuit, across which the submodule voltage Vc is present. A current connection point A1 of the unipolar submodule UM is constituted by the connection point between the two switches S1 and S2, and a further current connection point A2 is constituted by a connection point of the capacitor C. The current flowing in the submodule is identified by the reference symbol Im. If, in a blocked submodule—i.e. with the switching elements SE open—the current Im is positive, said current flows through the capacitor C, and the submodule voltage Vc is delivered as an output at the current connection points A1 and A2. If the current Im is negative, it bypasses the converter C, as it is diverted by the diode of the switch S2; the capacitor voltage Vc is not detectable at the current connection points A1 and A2.

FIG. 7 shows an exemplary embodiment of a bipolar submodule BM, which can be employed in the converter assemblies according to FIGS. 1 to 5. The bipolar submodule BM comprises two parallel-connected series circuits, each having two switches S1 and S2 or S3 and S4, each of which comprises a switching element SE and a parallel-connected diode D. A capacitor C is connected in parallel with the parallel circuit of the series circuits of the switches.

The bipolar submodule BM, in the blocked state, in the event of a positive submodule current Im, is capable of delivering a positive submodule voltage Vc at the current connection points A1 and A2 and, in the event of a negative submodule current Im, of delivering a submodule voltage Vc with a polarity reversal, i.e. with the opposite polarity or symbol.

Although the invention has been illustrated and described in greater detail with reference to preferred exemplary embodiments, the invention is not limited to the examples disclosed, and further variations can be inferred herefrom by a person skilled in the art, without departing from the protective scope of the invention.

### LIST OF REFERENCE SYMBOLS

10 Converter assembly
11 Converter unit
11a First converter unit
11b Second converter unit
20 Transformer
20a Transformer
20b Transformer
30 Circuit-breaker
40 Voltage limiting device
101 DC voltage connection point
102 DC voltage connection point
201 DC voltage connection point
202 DC voltage connection point
A1 Current connection point
A2 Current connection point
BM Bipolar submodule
C Capacitor
D Diode
FG Submodule group remote from ground
G DC voltage side
G1 DC voltage connection point
G2 DC voltage connection point
I1 Partial current
I2 Partial current
If Fault current
Im Current
N1 Network connection point
N2 Network connection point
N3 Network connection point
NG Submodule group close to ground
R1 Series circuit
R2 Series circuit
R3 Series circuit
R11 Connection point
R12 Connection point
R21 Connection point
R22 Connection point
R31 Connection point
R32 Connection point
Rb Series circuit
S1 Switch
S2 Switch
S3 Switch
S4 Switch
SE Switching element
UM Unipolar submodule
Vc Submodule voltage
W1 AC voltage connection point
W2 AC voltage connection point
W3 AC voltage connection point
Wa1 AC voltage connection point
Wa2 AC voltage connection point
Wa3 AC voltage connection point

1-16. (canceled)

17. A converter assembly, comprising:
at least one converter unit including at least two AC voltage connection points each configured for injecting or tapping an alternating current, and first and second DC voltage connection points each configured for injecting or tapping a direct current, one of said DC voltage connection points of said at least one converter unit being grounded;
said at least one converter unit including series circuits each associated with a respective one of said AC voltage connection points, said series circuits being electrically connected in parallel;
each of said series circuits including a respective first series circuit connection point connected to said first DC voltage connection point of said at least one converter unit, and a respective second series circuit connection point connected to said second DC voltage connection point of said at least one converter unit;
each of said series circuits including respective series-connected submodules;
said AC voltage connection point, in each of said series circuits, respectively subdividing said submodules into a submodule group being electrically closer to said first series circuit connection point and a submodule group being electrically closer to said second series circuit connection point;
said AC voltage connection point, in each of said series circuits, respectively subdividing said submodules into a submodule group being electrically closer to ground and a submodule group being electrically more remote from ground;
said submodule groups being closer to ground including at least one bipolar submodule; and
said submodule groups being more remote from ground including exclusively unipolar submodules.

18. The converter assembly according to claim 17, wherein each of said submodule groups being closer to ground have a ratio between a number of said bipolar submodules and a total number of said submodules of between ¼ and ¾.

19. The converter assembly according to claim 17, wherein:
said at least one converter unit includes first and second converter units each having at least two respective AC voltage connection points for injecting or tapping an alternating current and respective first and second DC voltage connection points for injecting or tapping a direct current;
said converter units each include a respective series circuit associated with each respective AC voltage connection point;
said series circuits of each converter unit are respectively electrically connected in parallel;
each series circuit has a respective first series circuit connection point connected to said first DC voltage connection point of a respective converter unit, and a respective second series circuit connection point connected to said second DC voltage connection point of a respective converter unit;
each of said series circuits includes respective series-connected unipolar submodules and bipolar submodules; and
said AC voltage connection point in in each of said series circuits respectively subdivides said submodules into a submodule group being electrically closer to said first series circuit connection point and a submodule group being electrically closer to said second series circuit connection point.

20. The converter assembly according to claim 19, wherein:
said first DC voltage connection point of said first converter unit forms a first DC voltage connection point of the converter assembly;
said first DC voltage connection point of said second converter unit forms a second DC voltage connection point of the converter assembly;
said second DC voltage connection points of said first and second converter units are grounded; and
said AC voltage connection points of said first and second converter units, in pairs, form an AC voltage connection point of the converter assembly, either separately or in combination with other components.

21. The converter assembly according to claim 20, wherein:
said associated AC voltage connection point, in each of said series circuits of said first and second converter units, subdivides said submodules into one respective submodule group being electrically closer to ground and one respective submodule group being electrically more remote from ground;
said submodule groups being closer to ground include at least one bipolar submodule; and
said submodule groups being more remote from ground exclusively include unipolar submodules.

22. The converter assembly according to claim 21, wherein each of said submodule groups being closer to ground have a ratio between a number of said bipolar submodules and a total number of said submodules of between ¼ and ¾.

23. The converter assembly according to claim 17, which further comprises at least one voltage limiting device protecting said bipolar submodules against overvoltages.

24. The converter assembly according to claim 17, which further comprises dedicated voltage limiting devices each being electrically connected in parallel with a respective one of said bipolar submodules.

25. The converter assembly according to claim 24, wherein said bipolar submodules each include a respective capacitor, and said voltage limiting devices respectively limit a capacitor voltage of said capacitor of a respective associated bipolar submodule to a predefined maximum capacitor voltage.

26. The converter assembly according to claim 17, wherein each of said bipolar submodules, in at least one of said submodule groups being closer to ground, is mutually interconnected within their respective submodule group being closer to ground, to form a series circuit of bipolar submodules.

27. The converter assembly according to claim 26, which further comprises voltage limiting devices each being electrically connected in parallel with a respective one of said series circuits of bipolar submodules.

28. The converter assembly according to claim 27, wherein said bipolar submodules each include a respective capacitor, and said voltage limiting devices respectively limit a sum of capacitor voltages of said capacitors of said bipolar submodules in said respective series circuits of bipolar submodules to a predefined maximum total capacitor voltage.

29. The converter assembly according to claim 17, wherein said modules are configured to cause at least one of:
said unipolar submodules to only deliver a submodule voltage with a single polarity, or
said bipolar submodules to optionally deliver a submodule voltage with a positive or a negative polarity, or
said bipolar submodules to optionally deliver a submodule voltage with a positive or a negative polarity, but at different voltage levels.

30. The converter assembly according to claim 17, wherein in said modules, at least one of:
said unipolar submodules are each formed by a series circuit having two switches, each of said switches includes a switching element and a parallel-connected diode, and a capacitor is connected in parallel with said series circuit, or
said bipolar submodules are each formed by two parallel-connected series circuits, each of said series circuits has two switches, each of said switches includes a switching element and a parallel-connected diode, and a capacitor is connected in parallel with said parallel circuit of said series circuits.

31. The converter assembly according to claim 24, wherein said voltage limiting devices include non-linear resistors or are formed by non-linear resistors.

32. The converter assembly according to claim 24, wherein said voltage limiting devices are arresters.
